(19) United States
(12) Patent Application Publication
(10) Pub. No.: US 2011/0088640 A1
(43) Pub. Date: Apr. 21, 2011

(54) IMPROVED FILM-COOLED INTERNAL COMBUSTION ENGINE

(76) Inventor: Samuel Draper, Simpsonville, SC (US)

(21) Appl. No.: 12/294,940

(22) PCT Filed: Mar. 28, 2007
(86) PCT No.: PCT/US07/07665

§ 371 Date: Sep. 29, 2008

Related U.S. Application Data
(60) Provisional application No. 60/786,693, filed on Mar. 29, 2006.

(51) Int. Cl. F02F 1/14

(52) U.S. Cl. 123/41.72

(57) ABSTRACT

The present invention provides an improved internal combustion engine that uses film cooling. Improved fuel efficiency and other parameters are achieved through the design and use of the present invention.

### CROSS-REFERENCE TO RELATED APPLICATIONS

This application relies on the disclosure of, and claims the benefit of the filing date of, U.S. provisional patent application No. 60/786,693, filed 29 Mar. 2007, the entire disclosure of which is hereby incorporated herein by reference.

### BACKGROUND OF THE INVENTION

1. Field of the Invention

The present invention relates to the field of internal combustion engines. More specifically, the invention relates to improved designs for internal combustion engines that improve fuel efficiency, reduce emissions, and reduce wear on internal parts of internal combustion engines.

2. Description of Related Art

Internal combustion (IC) engines have been used for many years to convert chemical energy stored in fuels to mechanical energy. The main components of an IC engine are a cylinder in an engine block, a reciprocating piston in the cylinder, a rotatable crankshaft, and a connecting rod, which transfers energy from the reciprocating piston to the rotating crankshaft.

The best automotive IC engines run at about 36% thermal efficiency at peak operating conditions. The remaining energy is lost through convection to the engine block, heat in the exhaust gas and unburned fuel. Almost 30% of the available energy from the fuel is lost through the heat convected to the engine block and removed by the engine radiator. About 8% of the potential energy is lost due to incomplete combustion of fuel in the cylinder.

Industry has long sought ways to reduce the heat transfer from the combusting gases to the engine block to get more mechanical power, increase life of engine parts, and reduce requirements for external cooling. For example, thermal barrier coatings have been applied to the inside of the cylinder, but those coatings were found to rub off as the piston reciprocated in the cylinder. In addition to saving fuel, reducing the heat transfer from combusting gases to the engine block also has application for the military where reduced thermal signatures are critical.

For many years, gas turbine engines have used “film cooling”, i.e., cooling with a flowing film of cool air between hot gases and temperature limited parts, to reduce transfer of heat by convection from combusting gases to the combuster walls. The flowing film of cool air against the protected surface permits operating the gas turbine at higher, and therefore more efficient, temperatures. Film cooling is also used on the outside of the turbine airfoils to achieve higher operating temperature and efficiency.

U.S. Pat. No. 6,951,193 to Draper discloses a film-cooled IC engine that uses film cooling to reduce heat transfer to the engine block, increase life of engine components, improve fuel combustion efficiency, and increase engine compression ratio. Film cooling applied to IC engines in accordance with that patent is disclosed as providing decreased part temperature, increased shaft power, reduced fuel flow to the engine, or any combination thereof.

Although film cooling has been shown to be applicable to gas turbine engines and IC engines, improvements to the design of IC engines and in implementation of film cooling are still needed to further improve the efficiency of internal combustion for production of useful power.

### SUMMARY OF THE INVENTION

The present invention provides an improved design for IC engines using film cooling. It further provides an improved method of providing film cooling for IC engines and processes. Innovative designs according to the invention provide, in various embodiments, improved fuel efficiency of the IC engine, reduced heat transfer to combustion chambers, reduced auto-ignition of fuel, and a reduction in unburned fuel. The innovative designs are also applied to several variations of IC engines, including spark ignition engines, diesel engines, HCCI engines, Stratified Charge Spark Ignition Engines, and Rotary internal combustion engines. The innovative designs also provide, in various embodiments, new and improved ways of providing fluids and fluid streams for films to provide film cooling.

In a first aspect, the invention provides an internal combustion (IC) engine, components of an IC engine, and products comprising an IC engine. The IC engine comprises at least one film hole in a cylinder or combustion chamber of the engine. The film hole provides an entrance for fluid to be introduced into the cylinder or combustion chamber of the engine. The location of the film hole is optimized for providing film cooling of the cylinder/chamber in which it is placed. For example, it is often placed at or in the immediate vicinity of the mate face between the cylinder head and engine block. Alternatively, it is often placed in a position that optimizes displacement of end gas, and thus is variable depending on the size and shape of the cylinder and/or combustion chamber.

As used herein, the term fluid includes any substance that has fluid properties, including but not necessarily limited to, gases and liquids. For example, a fluid may be a substance that exists in a gaseous state under conditions found in a combustion chamber or cylinder of an IC engine when in operation. Likewise, it may be a substance that exists in a liquid state under such conditions. As should be evident, the fluid may exist in any state at the site where it is stored. However, it will have fluid properties when introduced into a cylinder or combustion chamber of an internal combustion engine.

In a second aspect, the invention provides a method of fabricating an IC engine according to the first aspect of the invention. The method generally comprises fabricating an IC engine having parts well known in the art as suitable for inclusion in an IC engine, wherein one or more of the parts is modified to provide a fluid into a cylinder or combustion chamber for film cooling of the engine. The modification may be in any one or more parts of the engine. For example, it is often in the cylinder head, at or proximate to the surface that meets and physically contacts the engine block (i.e., at or near the surface forming the mate face). Alternatively, it is often in the engine block, at or proximate to the surface that meets and physically contacts the cylinder head (i.e., at or near the surface forming the mate face). Then again, it is often in the head gasket or functionally equivalent element, which is positioned between and physically in contact with the engine block and cylinder head. While the method of fabricating can comprise any number of known techniques, it often comprises forming a groove in the surface of the engine block, cylinder head, or both at the respective mate face surface(s), boring a hole or groove in or near the mate face surface of one or both of the engine block and cylinder head or in the head gasket, or casting the cylinder head, engine block, or gasket with a hollow passage, groove, or the like.

In a third aspect, the invention provides a method of introducing a film into a combustion chamber or cylinder of an IC engine. The method generally comprises providing a fluid into a combustion chamber or cylinder in a way such that the fluid forms a film that covers all or a part of the wall of the cylinder and/or chamber. The fluid is preferably provided in a manner such that it is introduced into the cylinder or chamber substantially parallel to the plane of the mate face of the engine block and cylinder head. It is also preferably provided in a manner such that it is introduced into the cylinder or chamber tangentially to the cylinder or chamber wall: It is also preferably introduced at a pressure that is sufficient to overcome the compression of the engine prior to combustion.

In another aspect, the invention provides a method of providing a fluid for film cooling of an IC engine. In general, the method comprises providing a source of the fluid and connecting the source to at least one cylinder or combustion chamber of an IC engine. The method typically further comprises introducing the fluid into at least one combustion chamber or cylinder of an IC engine. The method further typically comprises compressing or otherwise pressurizing the fluid to provide a means for introducing it into the cylinder or chamber. Often, the method further comprises regulating the amount, time, and/or pressure of the fluid being introduced into the combustion chamber or cylinder.

In yet another aspect, the invention provides a method of improving the fuel efficiency of an IC engine. The method generally comprises providing an IC engine, or portion thereof, comprising at least one film hole for introduction of a film for film cooling of the engine, and running the engine, thereby consuming fuel and producing energy. As used herein, improving fuel efficiency means increasing the amount of energy produced per unit fuel, as compared to another IC engine having the same physical components and materials, but without at least one film hole, or without a film hole oriented in accordance with the teachings of the present invention and used in conjunction with film injection pressures according to the present invention.

### BRIEF DESCRIPTION OF THE DRAWINGS

The accompanying drawings, which are incorporated in and constitute a part of this specification, illustrate several embodiments of the invention and together with the written description, serve to explain various principles of the invention.

FIG. 1 shows a cross-section of a 4 cylinder internal combustion engine, from the right.

FIG. 2 shows a cross-section of an internal combustion engine with a turbocharger, from the front.

FIG. 3 shows an enlargement of the internal combustion engine of FIG. 2 in the region of the cylinder head.

FIG. 4 shows a cross-section of an IC engine of an embodiment of the invention, in which a film is compressed with a turbocharger and supplied to a film manifold.

FIG. 5 shows a cross-section of a 5 cylinder engine according to an embodiment of the invention, in which one of the cylinders is dedicated to compressing film air.

FIG. 6 shows a cross-section of an IC engine according to an embodiment of the invention, in which the engine provides film groves in a mate face, where each film hole is attached to a connection pad.

FIG. 7 shows a cross-section of an IC engine according to another embodiment, in which the engine provides film groves in a mate face with 2 film holes fed from each connection pad.

FIG. 8 shows a cross-section of an IC engine according to yet another embodiment, in which the engine provides film groves in the mate face, where all film holes for a cylinder fed from a single connection pad.

FIG. 9 shows a cross-section through the film holes in the cylinder head mate face of an IC engine according to one embodiment.

FIG. 10 shows a cross-section enlargement of FIG. 9 in the region of two film holes, according to one embodiment of the invention.

FIG. 11 shows a cross-section of one cylinder from FIG. 8, in which a spark plug is depicted.

FIG. 12 depicts the cylinder of FIG. 11, in which the spark plug is closer to the uncovered region.

FIG. 13 depicts a cross-section through the cylinder head, engine block, and head gasket of an IC engine, showing a film channel as a groove entirely in the cylinder head.

FIG. 14 depicts a cross-section through the cylinder head, engine block, and head gasket of an IC engine, showing a film channel as a groove entirely in the cylinder head.

FIG. 15 depicts a cross-section through the cylinder head, engine block, and head gasket of an IC engine, showing a film channel as a groove entirely in the engine block.

FIG. 16 depicts a cross-section through the cylinder head, engine block, and head gasket of an IC engine, showing a film channel as a groove in both the cylinder head and engine block, and a break in the head gasket.

FIG. 17 shows a cross-section through the film holes in the cylinder head with the head gasket supported by a u-shaped channel, according to one embodiment of the invention.

FIG. 18 shows a cross-section through the film holes in the cylinder head with the head gasket supported by a plate, according to one embodiment.

FIG. 19 shows film holes in the spark plug according to one embodiment of the invention.

FIGS. 20A-E show, sequentially, the operation of a Wankle or Rotary Engine.

FIG. 21 shows application of film cooling according to the present invention to a Wankle or Rotary Engine.

FIG. 22 is a cross-section of a stratified charge engine according to one embodiment of the present invention.

FIG. 23 shows application of film cooling to reduce heat transfer to the pre-chamber of the stratified charge engine.

FIG. 24 shows an IC engine with a film plenum supplying fluid to four cylinders.

FIG. 25 shows an IC engine with a film plenum supplying fluid to four cylinders.

FIG. 26 shows an IC engine with a film plenum and an extra cylinder to provide pressurized fluid for film cooling.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description is provided as a detailed description of embodiments of the invention, and is not intended as a limitation on the scope of the invention to those particular embodiments discussed. As a general matter, features of IC engines that are not described in detail in this description are either well known in the art or evident to those of skill in the art, and thus need not be disclosed. For example, many features of the invention can be found in U.S. Pat. No. 6,951,193 to Draper, the entire disclosure of which is incorporated herein by reference.

In a first aspect, the invention provides an internal combustion (IC) engine, components of an IC engine, and products comprising an IC engine. In general, the products and articles of manufacture of this aspect of the invention comprises at least one film hole that is present in a surface defining a cylinder or combustion chamber of an IC engine. In essence, the film hole is present in any element that provides a surface defining or partially defining a cylinder or combustion chamber. Thus, it may be a surface of a cylinder wall, a surface of a head gasket, or a surface of a cylinder head. Likewise, it may be a surface of a spark plug or gasket or other seal for a spark plug.

There is no limitation on the size or shape of the film hole to be provided in the engine or engine part, as long as the sizes and shape are capable of providing film cooling of the cylinder in which or for which the hole is provided. Thus, the invention provides means for providing a film for introducing the fluid into the combustion chamber or cylinder. The means may be by way of any type of hole in a surface defining a cylinder or combustion chamber of an IC engine. In general, the size of the film holes is on the order of about 0.1 mm to about 2.5 mm, such as, for example. 0.5 mm, 0.75 mm, 1.0 mm, 1.25 mm, 1.5 mm, 1.75 mm, 2.0 mm, 2.25 mm, or 2.5 mm, or about these sizes. Of course, any particular size within these ranges may be selected, and the invention contemplates all such sizes without the need to list each specific size individually herein. In selecting a hole size for a particular engine design, one, some, or all of the following limits on the size of the film holes may be taken into consideration: it can be advantageous for the film hole to be small enough to prevent flame from propagating up the hole from the combustion chamber—although there are no absolute limits, in general, this size is roughly 0.5 mm to 2.5 mm, such as 1.0 mm; in addition, it can be advantageous for the film hole to be as large as possible to prevent plugging from the inside or outside; further, it is common knowledge that larger holes are easier to manufacture, while smaller holes tend to give better film performance per unit of film. In general, the film holes may be provided in a size range known for aircraft and industrial gas turbines, which are typically in the 0.5 mm to 2 mm range.

As mentioned above, the shape of the film holes may be varied based on numerous considerations. In general, the shape of the hole will often depend at first on manufacturing limitations. For example, when the film hole results from groves placed in the cylinder head or engine block at the mate face region, they are typically substantially square or rectangular in cross-section. Alternatively, round holes can be created by boring through one or more engine parts, or by forming a circular groove in two mating parts (e.g., cylinder head and head gasket). Likewise, semicircular or substantially semicircular holes may be fashioned by forming a circular groove in one part of an engine (e.g., cylinder head), and physically mating that part with another part having a flat surface (e.g., a head gasket). It is known that gas turbine film holes are often designed in a shape that permits diffusion of the film, for example by getting larger in cross-section from the beginning of the hole to its exit. This design is implemented to reduce the velocity, allowing it to better stay on the surfaces to be cooled. This principle may be applied to the film holes of the present invention as well. In embodiments, it is recognized that, because of the very slow or relatively slow velocities in the cylinder of an IC engine, high velocity jets of film will often travel tangentially around the cylinder, and the direction of the film path will be dominated by the hole direction. As a result, it is often desirable to have converging holes to accelerate the flow as it exits the holes.

Among the many part of an IC engine in which the film hole may be provided, three parts or elements are of particular interest. The first element is a cylinder block. The cylinder block may be fabricated from any material known in the art to be useful for a cylinder block of an IC engine, such as, but not limited to, cast iron or another iron-containing substance, aluminum or an aluminum-containing substance, and the like. The cylinder block comprises one or, typically, more (e.g., one, two, three, four, six, eight) cylinders of an IC engine. It thus can comprise a surface defining a cylinder, particularly a cylinder in which a piston is disposed. The second element is a cylinder head, often referred to simply as the “head” of an IC engine. The cylinder head may be fabricated from any material known in the art to be useful for a cylinder head of an IC engine, such as, but not limited to, cast iron or another iron-containing substance, aluminum or an aluminum-containing substance, and the like. This element typically comprises one or more spark plugs and a cavity defined by, or defined substantially by, a surface that, when combined with a cylinder block, forms a combustion chamber for ignition of a fuel/air mixture, such as a gasoline/air mixture. The cavity can be of any two- or three-dimensional shape. For example, it may be hemispherical. The third element is a gasket or other means for sealing the block to the head. The seal may be any type of seal known in the art, fabricated out of any suitable material. For example, it may be a head gasket formed from any material or combination of materials known in the art as useful for a head gasket. In preferred embodiments, the film hole is provided in or proximate to one or more surfaces of one or more elements that define a surface at which the head and block meet and are physically attached to each other, either directly or through an intermediate element (e.g., via a head gasket). As used herein, the region where these elements meet is referred to generally as a “mate face”, and this term is intended to generally encompass the surface and area immediately proximate to that surface of the head, the surface and area immediately proximate to that surface of the block, and any surfaces of elements interposed between these surfaces of the head and block, such as surfaces of a head gasket that is interposed between and physically connected to both the head and block. Thus, a film hole that is provided at the mate face may be provided in the mate face surface of the head, the mate face surface of the block, and/or the head gasket at either its mate face with the head, its mate face with the block, or as a through-hole in the gasket, which may provide the film hole by itself, or in conjunction with the head, the block, or both.

Other parts of the IC engine may also be modified by inclusion of a passage, such as a tunnel, tube, or other bored-out passage, through the part to permit passage of fluid from a source to the film hole. As used herein, the term “passageway” is used to denote this element, regardless of the part of the engine in which it is present. Techniques for boring tunnels and the like through engine elements are well known in the art, and any such technique may be used.

For example, a passageway may be provided in a cylinder head to permit passage of a fluid from a source of pressure, such as some type of pump, to a film hole in the surface of a cylinder or combustion chamber wall, or to another passageway in another element of an IC engine, where that passageway ultimately is connected to a film hole in a surface of a cylinder or combustion chamber wall. In embodiments, the passageway is connected, either directly or ultimately, to a film hole present at the mate face of the cylinder block and cylinder head, such as at a surface of a head gasket defining a portion of a surface of a cylinder wall.

For example, in embodiments, the invention provides an IC engine with at least one film hole in a surface defining a wall of a cylinder or combustion chamber, where the hole is present at the mate face region of the cylinder or combustion chamber. The IC engine may also comprise a film manifold (e.g., a chamber, plenum, cavity) in the mate face region. The film manifold is provided as an area where the fluid may collect prior to introduction into the cylinder or combustion chamber. It may function in embodiments as an area where compression waves associated with the pressurized fluid are, at least to some extent, dissipated prior to introduction of the fluid into the cylinder or chamber. In general, the film manifold is a portion of the passageway, which is larger, preferably substantially larger, than the other portions of the passageway and has a cross-section that is larger, preferably substantially larger, than the cross-section of the film hole. In embodiments, a single film manifold is provided per IC engine, the manifold being physically connected and in communication through film control valves with each film hole. In other embodiments, multiple film manifolds are provided, each serving one or more different film holes. Those of skill in the art are free to select combinations of film manifolds and film holes according to any number of parameters, in accordance with typical considerations in the art relating to ease of fabrication, strength of elements, and the like. The film manifold may be fabricated in any 3-dimensional shape, but is typically fabricated in a shape that provides the film to the film hole in a way that allows for introduction of the fluid into the combustion chamber or cylinder in a manner that provides film cooling according to the present invention. For example, the film manifold may be curved at or near the film hole to promote introduction of the film in a manner that is tangential to the cylinder or combustion chamber wall and substantially parallel to the plane of the mate face.

In embodiments, the IC engine also comprises at least one film channel. Like the film manifold, the film channel is an element that comprises part of the passageway of the invention. In general, the film channel is an open cavity, tunnel, through-hole, passage, etc. connecting the film manifold to the film hole. The film channel may be any suitable size (e.g., diameter) and any shape, and may vary in size and shape along its various axes. In general, the length of the film channel will be defined by the distance between the wall of the film manifold and the film hole. The film channel may be present in the IC engine as a single element, or more than one film channel may be provided. In preferred embodiments, one film channel is provided per combustion chamber of the engine, each film channel serving a single combustion chamber.

In certain embodiments, the film channel is defined on one end by the film hole and the other end by a valve or other means for controlling flow of fluid into the film channel and, ultimately, to the film hole. In these situations, the valve can be considered as disposed in the film manifold or simply within the passageway; the difference between the two is merely a matter of semantics. The valve may be any suitable valve for controlling flow of fluid from one portion of the passageway to another. Preferably, the valve is fabricated from materials that can withstand the changes in temperature associated with IC engines at rest, at start-up, and at operating temperatures (or above). Of course, while an engine may be provided with a single valve, in embodiments, one or more valves are provided per cylinder. Providing a valve, particularly when the valve is coupled with a film hole present at the mate face of the cylinder/combustion chamber permits delivery of a film to the engine block assembly from one passageway. The film does not leave the engine block assembly after that. This configuration provides a highly effective, economic, and simple design for an engine and its parts, and allows for fabrication of an engine according to the invention for practice of the methods of the invention.

The valve is controlled to provide film to the combustion chamber in time to displace end-gas and/or create an insulating layer between the combusting gas and cylinder walls. Previous solutions to film cooling of IC engines disclose timing of film valves relative to the crank angle of the engine. In contrast, the present invention times introduction of the film in such a way that the film valve is opened in time to allow film to travel down the film channels to the film holes, out of the film holes, and create a film before the combustion wave within the combustion chamber/cylinder arrives. Modern spark ignition engines change the timing of the spark plug, and thus ignition, and thus arrival of the combustion wave to different locations of the engine, relative to the crank angle of the engine. The spark may be advanced or retarded in order to optimize engine efficiency while avoiding knock or other adverse engine effects in relation to ambient conditions or operating conditions of the engine. It is preferred that the timing of the film valves is relative to the timing of ignition of the fuel air mixture in the cylinder, either by the spark plug, or by compression in a diesel engine. While any timing may be used, the timing is often such that opening of the valve will occur at about 10 to 20 degrees of crank angle before ignition and closing the valve at ignition or about 10 degrees after ignition. This will allow approximately 5% to 15% of the mass of fuel and air in the cylinder.

While the elements discussed above may be located at any site within the IC engine, it is recognized by the present invention that providing at least one film hole, at least one passageway to provide fluid to the film hole(s), at least one film manifold, and/or at least one film channel at or through the mate face region can reduce or eliminate much of the cost and many of the parts of the design of an engine according to the present invention, and thus is advantageous from the standpoint of cost and ease of fabrication. Placement at this area of the engine can also provide a benefit from the standpoint of performance of the methods of the invention by providing sufficient time for the film to equalize temperature with the engine block prior to combustion of the fuel.

In embodiments, an IC engine in accordance with this invention includes a cylinder having a wall defined by a surface, a piston which reciprocates in the cylinder, inlet and outlet valves in the cylinder, and means for opening and closing the valves as the piston reciprocates and periodically passes through intake, compression, combustion, expansion, and exhaust phases. A supply of compressed fluid delivers film cooling through at least one film hole via a film channel, which may pass from the exterior to the interior of the cylinder wall. The compressed fluid flows through the film hole and against the interior surface of the cylinder wall to provide a layer or film of fluid between the combustion gases and the cylinder wall to decrease transfer of heat through the wall. The temperature of the film is typically close to the temperature of the cylinder wall. It has been discovered that high temperature film reduces its effectiveness to reduce heat transfer and knock, and increases thermal stresses. In contrast, low temperature film requires rejection of energy to reduce its temperature, reducing efficiency and increasing thermal stresses, and potentially disrupting combustion processes. The temperature of the film will, of course, be optimized for each engine and temperature. In a preferred embodiment of this invention, the compressed fluid is exhaust gas produced by the engine. In this way, the fuel to oxygen ratio in the combustion chamber is not altered, and introduction of excess oxygen that will not combust is avoided, thus avoiding potential interference with catalytic converter operation. Alternatively, the compressed gas can be air, but this is not preferred when the engine exhaust gas is treated by passing it through a catalytic converter which cannot handle oxygen. Preferably, a control valve in a supply line which connects the compressed gas to the cooling channel is operated by a controller which opens and closes the central valve so that cooling fluid is supplied to the interior of the cylinder during the compression, combustion, or expansion phases of engine operation.

The IC engine of the invention comprises a source of fluid for film cooling. In embodiments, the source provides pressurized fluid. More specifically, the present invention contemplates use of pressurized fluid (e.g., some type of gaseous or liquid substance) to film cool at least one cylinder of an engine. The engine thus comprises in these embodiments a source of pressurized fluid, or a means for providing pressurized fluid. The source or means may be any suitable source or means, and is often a pump of some sort. In embodiments, the pressurized gas is supplied from a cylinder added to the engine block, which compresses the film and provides it to the passageway and ultimately to the film hole. It often is a cylinder that does not provide power directly for the engine to do work. In these situations, the cylinder is connected to at least one film hole, preferably by way of at least one film manifold, such as one mounted in the mate face to supply fluid to a film hole at the mate face of the cylinder/combustion chamber surface. In this way, in embodiments, such as those using one or more in-block valves, the film is confined to the engine block, providing ease of design, pre-heating of the film, and other advantages. Of course, in other embodiments, the cylinder is a cylinder that provides work output for the engine. In these embodiments, the cylinder can not only provide a source of pressure for the gas, but can also provide the gas, for example when exhaust gas is used as the gas for the film or for part of the film.

In other embodiments, the invention provides a Homogeneous Charge Compression Ignition (HCCI) engine. An HCCI engine intakes a premixed fuel and air mixture like a spark ignition gasoline engine. The mixture is compressed like a spark ignition engine. However, unlike a spark ignition engine, the mixture in an HCCI engine is ignited by compression of the gas like a diesel engine, rather than a spark plug. One challenge with the HCCI technology is that knock-prone regions in the cylinder will cause the mixture to combust at unpredictable times. Another challenge facing HCCI engine designers is that there is no way to control the desired timing of the combustion. The present invention addresses both of these concerns. First, the knock prone regions of the cylinder can be film cooled to reduce their tendency to knock. Second, the injection of film into the cylinder raises the pressure in the cylinder. In this way, the pressure in the cylinder can be timed to cause combustion by varying the timing of the film supply valves.

In preferred embodiments, the present invention provides means for covering all or part of a surface of a cylinder or combustion chamber in an IC engine with a cooling film. It has surprisingly been found that improvements in fuel efficiency, engine cooling, power, and reduction in auto-ignition can be achieved by covering all or part of the surface with a film comprising a fluid. In certain embodiments, the film, which is supplied via one or more film holes in the cylinder wall or combustion chamber wall, is directed toward the walls of the cylinder or combustion chamber. Film introduced, for example by injection, substantially tangential to the circumference of the cylinder, substantially parallel to the plane of the surface along which the block and head meet (i.e., the mate face), provides a film pattern that covers the cylinder wall at and/or around the introduction site (i.e., a film hole) and results in maintenance, for an effective amount of time, of the film substantially on or near the wall through the combustion and expansion stroke. In embodiments, the film displaces end gas and promotes proper combustion of end gas.

In embodiments, the film is supplied at a pressure that is optimized to be substantially the same as the peak pressure at the peak of compression within the cylinder. That is, if the engine were run without combustion, the peak pressure reached in the cylinder. The temperature of the film will be raised by compression to a level above the temperature of the walls of the cylinder. The film could be cooled to any temperature below that highest temperature. The cooling of the film represents a loss to the system, so the film temperature is advantageously as high as possible. Raising the film temperature significantly above the temperature of the metal of the cylinder might cause damage to the cylinder. The ideal temperature for film is as high as the material of the engine block will tolerate. It is likely only slightly higher than the temperature of the cylinder.

In various embodiments, means for providing the fluid into the combustion chamber or cylinder are provided. The means may be any physical element that permits introduction of a fluid into the chamber or cylinder. Non-limiting examples include any type of point of entry into the cylinder or chamber, such as holes, ports, grooves, and the like. The means may also include elements for moving the fluid to and/or beyond the point of entry into the cylinder or chamber, such as passageways in one or more elements of the internal combustion engine, such as in the cylinder head, head gasket, or engine block. In embodiments, means for providing a pressurized fluid are provided. Likewise, means for controlling flow of the fluid to the cylinder or chamber may be provided.

Thus, it should be evident that, in its various embodiments, the present invention provides an internal combustion engine comprising a block and a head, wherein the block comprises a surface defining a face for physical connection of the block to the head, and the head comprises a surface defining a face for physical connection of the head to the block, and wherein the head and block are connected, either directly or through an intermediary element at a region defining a mate face; and wherein the block and head each comprise at least one surface that, taken together, form a wall of a chamber, where the wall of the chamber comprises at least one film hole for introduction of a fluid into the chamber at an angle substantially parallel to the plane of the mate face. In certain configurations, the engine comprises at least one film hole at the mate face. The engine may also be configured such that at least one film hole is located in the chamber wall at a position that results in displacement of end gas upon introduction of a film into the chamber. The engine may comprise an intermediary element at the mate face, which comprises a seal interposed between and in physical contact with the block and head. Of course, the surface forming a wall of a chamber may comprise more than one film hole, and the engine may comprise more than one chamber. For example, the engine may comprise 1, 2, 3, 4, 6, 8, or 12 chambers. Indeed certain engines for large vehicles or airplanes may comprise a large number of chambers, such as, but not limited to, 18, 24, 48, or more chambers. The number of chambers is not critical to practice of the invention, and may be varied in accordance with the power, fuel efficiency, size, or any other parameter of interest to the practitioner.

The engine according to the invention may also comprise a film channel in or in proximity to either or both of the head and block surfaces at the mate face region. For example, the engine may comprise a film channel in which a groove is cut in one or more surfaces comprising the mate face. Some embodiments of the invention comprise a source of the fluid and at least one passageway connecting the film hole to the source of the fluid. The engine may also comprise at least one control valve to control the timing and/or volume of fluid entering the chamber. It has been found that in some situations one might wish to design the film hole such that fluid introduced into the chamber is introduced against the surface of the chamber. In other configurations, the engine comprises a film manifold located in a groove in the mate face, and/or a compressor that compresses the fluid, wherein the compressor is driven by a turbine run off of exhaust gas from the engine, a piston-cylinder combination, an electric pump, or a belt-driven pump. As should be evident, the engine may be any type of IC engine, including a rotary engine. It also may be present as a part of a vehicle (e.g., car, bus, train, airplane, military vehicle, motorized scooter, tractor or other farm or lawn equipment, etc.) or as part of a stationary object (e.g., power generator, human-propelled lawn mower).

In various embodiments, the invention provides an internal combustion engine comprising a block and a head, wherein the block and head are physically connected at a mate face, wherein the block and head each comprise at least one surface that, taken together, form a wall of a chamber, said wall of said chamber comprising at least one film hole for introduction of a fluid into the chamber that causes end gas to burn substantially as a result of the combustion wave and not auto-ignition or knock, more completely and/or effectively than an identical engine without the film hole(s). The various configurations and optional elements discussed above may also be present in these embodiments of the invention. Of particular note are configurations where the film hole is designed to allow introduction of the fluid against the surface of the chamber; the film hole is designed to allow introduction of the fluid substantially parallel to the mate face; the film hole is designed to cause displacement of end gas by the fluid film introduced through the film hole; and/or the film hole location is selected in conjunction with the chamber shape to cause displacement of end gas upon introduction of the fluid through the film hole during operation of the engine. Of course, these embodiments also contemplate a vehicle comprising the engine or a stationary object comprising the engine.

The invention also provides parts or portions of an IC engine. Thus, it provides a cylinder head for an internal combustion engine comprising at least one passageway for passage of a fluid to at least one film hole in a surface of at least one cylinder wall defined, at least in part, by the cylinder head. The cylinder head may comprise, in the passageway, one or more manifolds for supply of a film to at least one cylinder defined by a cylinder wall. The passageway may be present, at least in part, at or in a surface of the cylinder head defining a face for physical connection, either directly or ultimately, of the head to an engine block. In accordance with the discussion above, the invention provides a vehicle and/or stationary object comprising the cylinder head.

In addition, the invention provides an engine block for an internal combustion engine. The block comprises at least one passageway for passage of a fluid to at least one film hole in a surface of at least one cylinder wall defined, at least in part, by the engine block. The engine block may further comprise, in the passageway, one or more manifolds for supply of a film to at least one cylinder defined by a cylinder wall. The passageway may be present, at least in part, at or in a surface of the engine block defining a face for physical connection, either directly or ultimately, of the block to a cylinder head. As should be evident, the invention also provides a vehicle or stationary object comprising the engine block of the invention.

It will be apparent to those of skill in the art that the present invention provides any and all articles of manufacture and products having an IC engine according to the present invention. Thus, the invention provides for all types of vehicles that utilize an IC engine, such as, but not limited to, automobiles, trucks, vans, military ground vehicles (e.g., tanks, troop carriers), boats, airplanes, helicopters, submarines, and the like. It further provides for stationary objects comprising an IC engine, including, but not limited to, stationary or portable electric generators. Likewise, the invention provides all parts of IC engines that are modified to provide a film hole and method according to the present invention. Thus, it provides modified cylinder blocks, cylinder heads, and head gaskets, to name a few.

It will be apparent to those of skill in the art that the present invention provides any and all articles of manufacture and products having an IC engine according to the present invention. Thus, the invention provides for all types of vehicles that utilize an IC engine, such as, but not limited to, automobiles, trucks, vans, military ground vehicles (e.g., tanks, troop carriers), boats, airplanes, helicopters, submarines, and the like. It further provides for stationary objects comprising an IC engine, including, but not limited to, stationary or portable electric generators. Likewise, the invention provides all parts of IC engines that are modified to provide a film hole and method according to the present invention. Thus, it provides modified cylinder blocks, cylinder heads, and head gaskets, to name a few.

In a second aspect, the invention provides a method of fabricating an IC engine having at least one film hole in a surface defining a cylinder or combustion chamber. The method generally comprises fabricating an IC engine having parts well known in the art as suitable for inclusion in an IC engine, wherein one or more of the parts is modified to have a hole in a surface defining a cylinder or combustion chamber, wherein the hole is present to provide a port for introduction of a fluid for film cooling of the cylinder, or a portion of the cylinder. In embodiments, the film is capable of cooling, at least to some extent, the engine for which the cylinder comprises a part. Fabrication of the engine may be by any techniques known to be suitable in the art of IC engine designing and building, and selection of any one particular technique may be made by those of skill in the art based on any number of typical considerations.

The film hole may be introduced into the cylinder or combustion chamber surface using any technique, including, but not limited to, cutting, boring, drilling, punching, grinding, etching, and the like. Additional non-limiting examples of methods for providing the film hole include casting the element with a cast that provides a hole in the selected surface. Thus, the hole may be provided at the time of fabrication of the element, or may be introduced at a later time. As a general matter, any suitable means for introducing the film hole may be utilized.

In preferred embodiments, one or more film holes are provided at or in the immediate area of the mate face between the block and head. Thus, in embodiments, the method of fabricating an IC engine comprises fabricating a head with at least one film hole for introduction of a fluid into at least one combustion chamber or cylinder of an IC engine. In preferred embodiments, the hole is provided as a groove in the head mate face surface. In other embodiments, the method comprises fabricating a block with at least one film hole. In preferred embodiments, the hole is provided as a groove in the block mate face surface. In yet other embodiments, the method comprises fabricating a gasket or other sealing means with at least one film hole for introduction of a fluid into at least one combustion chamber or cylinder of an IC engine.

The film hole(s) in the surface of the cylinder or combustion chamber may be made by any suitable technique. For example, a hole may be bored into the surface by drilling or other technique that results in a suitable size and shape for the hole. Alternatively, it may be cut into one or more mate face surfaces as a groove or channel prior to assembling the IC engine. Likewise, it may be introduced during fabrication of a sealing means for sealing a head and block of an IC engine, such as when fabricating a head gasket. The angle at which the hole is created can be adjusted, if necessary, to provide the desired angle of introduction of fluid into the cylinder or combustion chamber. Alternatively, the hole may be provided in various shapes. Yet again, the angle at which the fluid is introduced into the cylinder or chamber can be adjusted by adjusting the shape of one or more chambers connected to the film hole. For example, a chamber may be provided immediately adjacent to and directly in connection with the film hole, where the chamber shape is designed to provide pressurized fluid that enters and exits the film hole tangential to the surface of the cylinder or combustion chamber. Likewise, the chamber may be designed to provide fluid to the hole such that the fluid, when it enters the cylinder or combustion chamber, enters substantially parallel to the plane of the mate face.

In general, the film hole(s) and passageway(s) are provided in the engine and its constituent parts in a manner that allows for practice of at least one embodiment of the method of the invention. Thus, various modifications of an IC engine and its parts, during fabrication or after completion of assembly of the engine, may be made to provide the physical elements that allow for practice of one or more embodiments of the methods of the invention.

In embodiments, the method of fabricating an IC engine comprises providing at least one film hole in at least one other or additional element of an IC engine, such as a film hole in a surface of a cylinder block defining a cylinder within the block, or a film hole in a surface of a cylinder head defining a cylinder or combustion chamber within the head. The method may also comprise providing a passageway for passage of a film from a source (e.g., a pressurized source) to the film hole. The passageway may be provided in one or more elements of the IC engine, and two or more passageways may connect to form one or more continuous passageways from one element to another of the IC engine. As a general matter, the IC engine and parts thereof are fabricated to permit the methods of the invention to be practiced. Thus, various modifications of an IC engine and its parts, during fabrication or after completion of assembly of the engine, may be made to provide the physical elements that allow for practice of one or more embodiments of the methods of the invention.

It is thus evident that, in its various embodiments, the invention provides a method of fabricating an internal combustion engine or a portion thereof, where the method comprises providing at least one film hole in a surface defining a piston cylinder or combustion chamber, wherein the film hole is present at a mate face between a cylinder head and engine block of the engine. The method may further be characterized in embodiments in that the film hole is designed such that fluid introduced into the chamber from the film hole is directed against the surface of the chamber; and/or the film hole is designed such that fluid introduced into the chamber from the film hole is introduced substantially parallel to the mate face. The method further optionally comprises providing at least one passageway for a fluid to travel from outside the engine to the film hole and/or providing more than one film hole.

In a third aspect, the invention provides a method of introducing a film into a combustion chamber or cylinder of an IC engine. The method generally comprises providing a fluid, such as a gas or liquid, and introducing the fluid into the cylinder or combustion chamber to provide a film on or over some or all of the surface of the cylinder, chamber, or both. In embodiments, the film covers less than the entire surface. For example, the film may cover about or exactly 10%, 20%, 30%, 40%, 50%, 60%, 70%, 80%, 90%, 95%, 99% or greater than 99% of the surface. Thus, it may be 100%. Where multiple holes are provided in the cylinder surface, the combustion chamber surface, or both, the total surface area covered can be less than the entire surface, as discussed immediately above. However, where multiple holes are provided, the holes may be positioned, and fluid introduced, in a way that maximizes total surface area coverage, thus achieving a higher total surface area coverage than possible with one hole alone.

The hole(s) may be provided at any suitable place in the surface of the cylinder or combustion chamber. It is preferred that the hole(s) be placed in the surface such that injection of the fluid results in film cooling of the end-gas region of the combustion mix. Accordingly, the film hole may be positioned after consideration of the overall design of the cylinder and combustion chamber, including the cylinder head in general, to provide for displacement of the end-gas by the film. Accordingly, the method may be considered a method of film cooling the end-gas region of a fuel mixture or combustion reaction mixture.

The gas may be any substance that exists in a gaseous state under the physical conditions present in the cylinder or combustion chamber at the time of introduction. Thus, it may be air or a component of air, such as carbon dioxide, nitrogen, hydrogen, oxygen, or any other molecule found in air, or a mixture of two or more of these. Preferably, the gas does not comprise an element or molecule that negatively affects combustion or emissions of the IC engine. Thus, it is preferably not oxygen. In certain embodiments, the gas is exhaust gas that has been re-circulated from the exhaust of the engine.

Preferably, the fluid is provided in a pressurized state, although it is to be understood that the conditions in the cylinder and/or combustion chamber may be such that they provide an effectively low pressure so as to suck the fluid into the cylinder or chamber. Pressure may be provided by any number of devices or techniques, including, but not limited to those discussed below. Introduction of fluid into the chamber may thus be by injection, blowing, and the like.

It has surprisingly been found that the angle of introduction of fluid into the chamber, and in particular introduction at a certain point in the cylinder/chamber at a certain angle and/or at a certain pressure, can cause formation of a film, and swirling of that film to form a highly effective film coating of the surface of the cylinder/chamber. This swirling effect provides numerous advantages in various embodiments, including, but not limited to, cooling of the cylinder and/or combustion chamber surface, dislodging of collected unburned fuel (and subsequent burning of it) to increase fuel efficiency, cooling of valves, including exhaust valves, enabling higher compression ratios, and extracting more usable energy from a unit of fuel.

As would be understood from the above disclosure, the invention provides in embodiments a method of introducing a film into an internal combustion engine, where the method comprises providing an internal combustion engine having at least one chamber defined by a surface of a cylinder head and a surface of an engine block, wherein the cylinder head and engine block are physically connected at a mate face, wherein the surface of the chamber comprises at least one film hole for introduction of a fluid into the chamber to displace end gas; and operating the engine, wherein operating the engine comprises introducing a fluid into the chamber through the film hole. In embodiments, the method is a method of improving the fuel efficiency of an engine by causing the displaced end gas to burn, wherein the improvement is seen as compared to an identical engine but without the film hole(s). The method can also be a method of film cooling of an engine. In embodiments, the method improves the percentage of fuel burned by the engine, as compared to an identical engine without the film hole(s). In the method, at least one film hole may be created at the mate face. In addition, in some embodiments, the temperature of the fluid, when introduced into the chamber, can be substantially the same as the surface at the film hole.

In variations of the method, the invention provides a method of providing fluid for film cooling of an IC engine. In general, the method comprises providing a source of the fluid, which is preferably a source that can provide the fluid under pressure, and connecting the source to at least one cylinder or combustion chamber of an IC engine. Connecting the source to the cylinder or chamber may be through any suitable method or technique, but is typically achieved by boring, drilling, etc. a passage through at least a part of at least one element of an IC engine, or providing a tube or other element that can conduct the fluid to the hole. Of course, a combination of elements, where one (or more) is a passage through an element and one (or more) is a separate element, may be used.

The method typically further comprises introducing the fluid into at least one combustion chamber or cylinder of an IC engine. Introducing may be through any suitable technique, such as injection, blowing, or sucking. Often, the method further comprises regulating the amount, time, and/or pressure of the fluid being introduced into the combustion chamber or cylinder. It has surprisingly been found that a particular angle of introduction of the fluid, coupled with a particular pressure and time of injection provides optimal film-forming characteristics, and provides unexpected benefits for cooling, fuel efficiency, and part maintenance.

In yet another aspect of the method, the invention provides a method of improving the fuel efficiency of an IC engine. The method generally comprises providing an IC engine, or portion thereof, comprising at least one film hole for introduction of a fluid for film cooling of the engine; and running the engine, thereby consuming fuel and producing energy. The production of energy in the IC engine of the invention is improved, as compared to a similar IC engine without the modifications according to the present invention. As used herein, production of energy means production of energy that is useful for doing work in a manner envisioned by the design of the engine. It thus will rarely be heat energy, as this is typically considered a waste product of fuel consumption. However, where heat is used to enhance the useful energy output of the engine, it may be included as part of the improvement.

In embodiments, fuel efficiency of an engine may be improved by linking the timing of film introduction to spark timing. According to these embodiments, in a spark ignition engine, the film is injected not in response to the position of the piston as other inventions have disclosed, but rather in response to the spark plug firing. An engine control module may be present, which changes the ignition timing relative to the crank angle in response to ambient conditions, engine load, and other factors. The engine control module can be used to also control film control valves in relation to the firing of the spark plug, rather than the location of the piston. In this way, introduction of the film can be related directly to combustion timing, rather than to piston location, a relationship that is much better suited for improvement of fuel efficiency. Of course, where desired, a separate control module may be included for film introduction. Regardless of the number and positioning of control modules, it is preferred that in these embodiments, timing of film introduction be adjusted in consideration of spark timing rather than piston position.

Having discussed the invention in general terms, various embodiments and features provided in embodiments will now be discussed. Each of the following concepts, advantages, and combinations of elements are provided for, alone or in any combination, by the invention.

The present invention allows design of an IC engine, and a method of using an IC engine, such as in a manner that provides improved fuel efficiency. It has been surprisingly found that particular placements of film holes for introduction of a fluid into an IC cylinder or combustion chamber, and particular angles for introduction of the fluid, coupled with various pressures of introduction of the fluid, provide unexpected improvements in fuel efficiency of IC engines, as well as other advantages. One feature of the invention that has been unexpectedly found is that advantages and improvements may be achieved by using a fluid film to displace the end-gas in a cylinder/combustion chamber during combustion of fuel.

The efficiency of spark ignition internal combustion engines has increased since the oil embargo of the 1970s, largely through increases in compression ratio. Compression ratio is the ratio of the highest volume in the cylinder during the cycle, when the piston is at the bottom of its stroke (bottom dead center), to the lowest volume in the cylinder during the cycle, when the piston is at the top of its stroke (top dead center). The smallest volume is often called the combustion chamber. Modern production four stroke spark ignition engines running on “regular unleaded” gasoline are limited to compression ratios of approximately nine.

The limit on compression ratio is knock. Knock is ignition of the fuel and air mixture in the combustion chamber not caused by the spark plug, but by excessive temperatures and pressures locally in the cylinder. Knock usually occurs after the spark has fired and the pressure in the cylinder is rising as the combustion wave is traveling away from the spark plug toward the edges of the cylinder. The fuel and air mixture ahead of the combustion wave is raising in pressure like the combustion products behind it. For a brief time, the fuel and air mixture last to combust experiences very high pressures and temperatures before the combustion wave reaches it. This last mixture to combust is referred to as the “end-gas”.

The characteristics of the end-gas govern the propensity to knock in the combustion chamber. Equation (1) from Douaud and Eyzat is the most used equation for predicting the onset of knock. As Tau falls, knock is predicted. The equation shows high temperature, high pressure, and low octane number lead to knock.

$$τ = 17.68 {( \frac{ON}{100} )}^{3.402} {p}^{- 1.7} {e}^{( \frac{3800}{T} )} \qquad ( 1 )$$

The literature suggests that the best way to eliminate knock is to have very high heat transfer to the cooler cylinder walls during compression, then to have very low heat transfer during combustion and expansion. Unfortunately, it is difficult to add traditional features to the cylinder to increase heat transfer during one part of the cycle, and reduce heat transfer during another.

Proposed here is the novel concept of using film cooling to reduce the temperature of the end-gas, thereby greatly reducing the likelihood of knock in the cylinder. Modeling has shown that the compression ratio of the engine can be increased from nine to at least twelve with effective film cooling of the end-gas. The present invention thus provides a practical solution to the problem of knock and low compression ratios.

One feature of the invention is providing a fluid for use as a film within an IC cylinder. One way to provide this film to the cylinder is through the use of a turbocharger. An automotive turbocharger uses a turbine in the exhaust stream to convert heat and pressure in the exhaust to mechanical energy. That mechanical energy is used to drive a compressor to compress all the air used by the engine. The compression ratio of the turbocharger is between 1.5 and 3. This increase in pressure increases the mass flow to the engine thereby increasing the power of the engine. Disclosed here is the novel application of a turbocharger to compress not all the air, but only the film. Further, the turbocharger can be designed to compress the film to a pressure sufficient for the film cooling system, the pressure of peak compression.

Another solution to the need to provide a pressurized fluid to the cylinder is to add one or more cylinders to the engine block to compress the film. In many embodiments, the film-cooled internal combustion engine of the invention uses a supply of compressed fluid. Disclosed here is the novel addition of a cylinder to the engine block to supply that compressed fluid. The cylinder has intake and exhaust ports, and a piston connected to the crank shaft. The cylinder does not need to have a spark plug, and fluid for it can be supplied from a separate supply than the other cylinders. The compressed film from this cylinder exits through its exhaust port to the film plenum. That cylinder does not have to be the same design or size as the other cylinders. In embodiments, the cylinder can be cycled on and of to compress the film, reducing drag on the engine as a whole and further improving fuel efficiency. Automobile manufacturers have already developed “displacement on demand” technology. That technology disables some cylinders in the engine when the engine control module determines the fuel economy would be improved to do so. When high power is required, during acceleration or towing, the cylinders are activated. When low power is required, the cylinders are deactivated to improve fuel economy. Disclosed here is the novel approach of using the cylinders to generate power when power is required, and to compress air to be used for film cooling in the energy efficiency mode.

Another feature of the present invention is to manufacture holes by groves in the mate face between the block and the cylinder head, and use of injection of film substantially tangential to the cylinder wall at the junction of the cylinder wall and cylinder head. Detailed CFD has shown that reduction in knock at elevated compression ratios is a major benefit of the present technology. This knock reduction is facilitated by reducing the temperature and fuel/air ratio in the combustion gases in the ‘end gas’ region of the combustion chamber. The “end gas” region is the volume of the cylinder last reached by the propagating combustion wave. This is characterized most dominantly by being the farthest from the spark plug. In modern engines, the spark plug is very near the center of the cylinder head, making the end gas region around the perimeter of the cylinder. One of skill in the art can easily determine the area of end gas using well tested modeling techniques. Any area where the flame speed is reduced due to tight spaces or increased due to high temperatures can alter the exact location of the end gas.

In a spark ignition engine, the flame front, or combustion wave, begins at the spark plug. Substantially, the combustion wave propagates away from the spark as a sphere of increasing size. The sphere's shape is modified by the walls of the combustion chamber. The wave continues to propagate away from the spark until the wave encounters all the walls of the combustion chamber and combusts all the fuel and air mixture. The shape of the combustion wave is affected by the presence of cylinder walls, and also by variations in the speed of the flame front. Flame speed is governed by four main parameters: the fuel/air ratio, the temperature of the mixture; the pressure; and the turbulence level. These characteristics are well known to those skilled in the art and those designing combustion chambers for internal combustion engines. Computational Fluid Dynamics (CFD) can be used to model all the phenomena in the cylinder to predict the location of end gas. Substantially, the flame speed in a combustion chamber is constant, meaning that assuming the end gas will be the region of the cylinder furthest away from the spark plug is close to correct.

A benefit of the present technology that is provided in embodiments is reduced heat transfer by reducing the gas temperature against the walls of the combustion chamber. The detailed CFD has shown that film persists the longest when it is injected tangentially at the interface between the cylinder head and cylinder walls. The tangential injection of flow causes the film to travel around the cylinder covering a maximum percentage of the perimeter with a minimum of film and film holes. As few as 4 holes has been shown effective in creating a substantially axisymmetric film layer around the cylinder. There is no reason, however, to assume that fewer than 4 holes, for example 3 holes, 2 holes, or 1 hole, would not work in the same manner, that is, to provide improved fuel efficiency or one or more of the other advantages discussed herein. The tangential acceleration of the film as it travels around the cylinder causes it to remain against the cylinder walls. Of course, more holes can be introduced and used to provide additional benefits. In order to create these film holes in the plane of the head gasket, the following techniques may be used, in consideration of the following issues: the film cooled internal combustion engine requires passages in the engine block not previously present. Modern, water cooled internal combustion engine blocks have a water jacket and cooling passages, oil passages, and air inlets and outlets. Disclosed here is a novel approach to create the passages required to get the film into the block, avoiding the many obstacles. Engines are constructed of an engine block and a cylinder head. There is a mate face between the cylinder head and the engine block. A pattern of grooves in either the cylinder head mate face or the engine block mate face, or the head gasket, or a combination of those, could be used to create channels for film to pass.

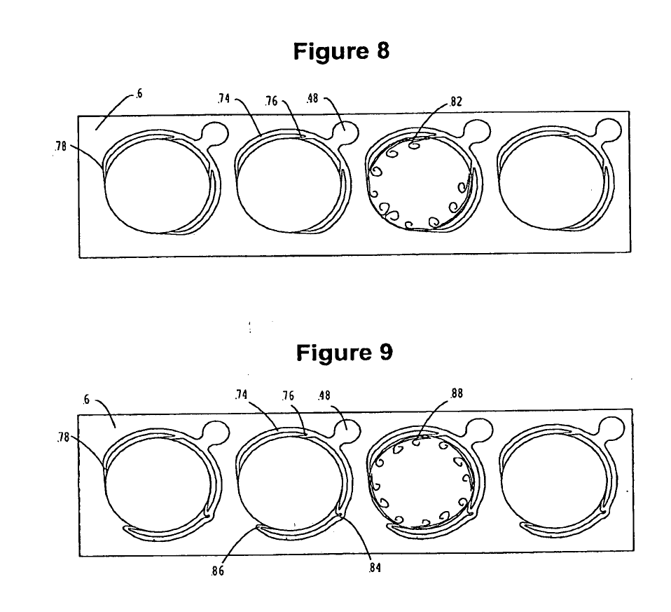

In embodiments, a pattern of channels is installed in the mate face to deliver film to the regions of the cylinder requiring film cooling. A fluid connection is required between the channels in the mate face plain and the film control valve. Each film hole could be individually connected to a control valve, or the holes can be ganged. In ganged film hole arrangements, especially those where one film valve controls all the film for a cylinder, it is difficult to completely cover the perimeter of the cylinder head with film. FIG. 8 shows a film pattern with an unprotected region of the cylinder wall. In order to protect the cylinder from knock when part of the end-gas is not film cooled, the spark plug is located closer to that portion of the cylinder wall. This closer spark plug causes the region of no film cooling to combust before knock is expected, and limits the end gas to regions where film is present.

Another solution for providing the holes is to install film holes in the spark plug. Spark ignition engines use spark plugs to deliver an electric charge to ignite the compressed fuel air mixture. The spark plug has been used experimentally as a path through the intricate cylinder head to the combustion chamber to route thermocouples and pressure sensors. Disclosed here is a novel method of applying film cooling to an internal combustion engine by routing the film air through the spark plug. Film fluid is fed to the spark plug and passes through the spark plug to be injected into the combustion chamber. The head of the spark plug is designed to divert film air away from the spark. The control valve controlling the injection of film air could be incorporated into the spark plug.

Yet another innovative design provides, in embodiments, a valve seat with film holes. As the operating conditions of the internal combustion engine become more severe, the exhaust temperature from the cylinder increases. At the power levels and engine conditions of racing engines, such as NASCAR, the exhaust temperature is high enough to cause significant damage to exhaust valves and exhaust valve seats. Disclosed here is a novel concept to use film cooling to reduce the temperature of the exhaust valve seat and exhaust valve. The concept requires a supply of cooling film at a pressure sufficient to drive flow during the exhaust stroke. The holes are placed in the face of the exhaust valve seat such that they are closed by the valve. When the valve opens to exhaust the cylinder, the film holes are uncovered, and flow film air to insulate the exhaust valve seat. This effect can reduce the temperature of the air in contact with the exhaust valve seat by up to 250 degrees Fahrenheit.

Yet another feature, in embodiments, is to add fuel to film in equal or less quantities than the fuel air ratio in the cylinder—using EGR to maintain overall F/A ratio. That is, the film fluid will include fuel in a lower fuel to air ratio than that found in the cylinder into which it is to be introduced. As film is added to the clearance volumes and injected tangentially around the cylinder, it will entrain fuel previously trapped in the tight spaces, especially in the piston ring area. That fuel will be mixed with film, which is a mixture of air or exhaust gas or other fluid. The entrained fuel in the film may result in a fuel to air ratio too low for the entrained fuel to combust. Disclosed here is the novel concept of added an amount of fuel to the film to raise the fuel to air ratio of the film region above the level that will combust when combined with the entrained fuel from the tight spaces. The amount of fuel added to the film will make the fuel to air ratio in the film in the film hole lower than the fuel to air ratio in the combustion chamber before film injection.

Yet again, the means of adding fuel to the film prior to film injection may be a carburetor or fuel injector. The means are preferable disposed before the film compression system, reducing the requirements for pressure rise in the fuel delivery system.

In embodiments, a mechanical film valve is present. To date, the FCIC technology has assumed the use of an electronic control valve to open and close to allow film into the film passages at the proper times. Disclosed here is the novel concept of using a mechanical valve like the intake valve on the cylinder to control the film to the cylinder. The valve would operate like the intake valve, including opening and closing in response to action of the cam shaft and follower.

To date, the film-cooled internal combustion engine technology has assumed the use of an electronic control valve to open and close to allow film into the film passages at the proper times. Disclosed here is the novel concept of using a passive mechanical valve system to open and close the film passages in response to the relative pressure in the cylinder to the pressure in the film supply system. Two check valves in series illustrates the operation of the system in embodiments. The system is arranged with a first normally open check valve facing with its down-stream direction to the film supply manifold. That valve is connected to a second normally open check valve with its down-stream direction to the film delivery system to the combustion chamber. When the film supply pressure is much higher than the combustion chamber pressure (during exhaust, intake, and the beginning of compression), the first valve is closed in response to the high pressure on it, and the second valve is open. The film flow is closed off due to the first valve. When the film supply pressure is close to the combustion chamber pressure (near peak compression), the first valve opens to its normally open state, allowing film to pass. When the film supply pressure is lower than the combustion chamber pressure (after spark firing), the second valve closes. This arrangement creates a band-pass valve system requiring no control system, with the timing of film flow governed by the spring tensions in the check valves.

In embodiments, the engine and method comprise heat exchanged to the fuel to cool film. When the film gas is compressed, its temperature will rise above the ideal temperature for injection. The ideal temperature for injection is the cylinder wall temperature. A heat exchanger could be used to reduce the temperature of the compressed film gas prior to injection to the cylinder. Proposed here is the novel concept of using the heat from the heat exchanger to heat the fuel before it is used in the engine. This will eliminate the loss of efficiency associated with cooling the film gas.

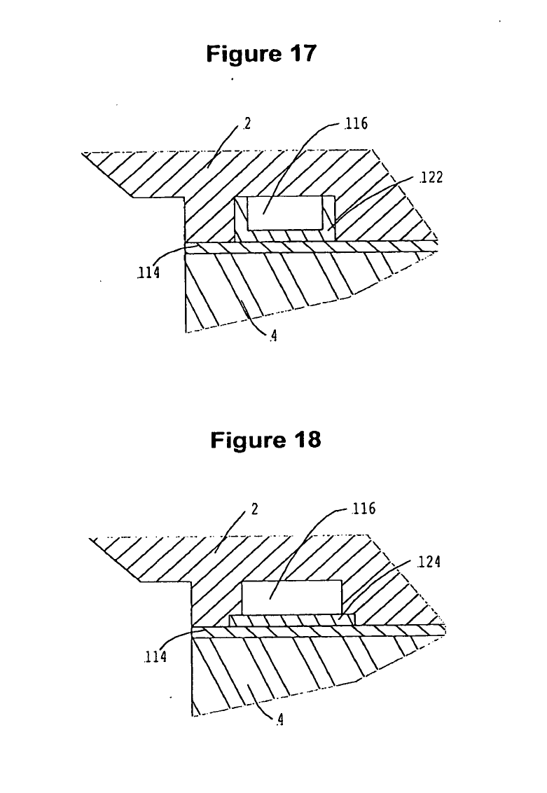

The present invention is equally applicable to rotary engines. Wankle engines or rotary engines are alternatives to reciprocating engine geometry. The engine operates with an equivalent cycle to a four stroke reciprocating engine, passing through intake, compression, power, and exhaust strokes. FIG. 16 shows these steps. The reciprocating piston is replaced by a rotor specially designed to facilitate the cycle. The Wankle engine has inherent difficulty with heat transfer and leakage, but has the advantage of smooth operation and high power density. Proposed here is the novel concept of using film cooling on the Wankle engine to reduce heat transfer during the high temperature operation of the cycle. FIG. 17 shows conceptually where holes could be placed in the cylinder walls fed by a film plenum, in the rotor fed by a film plenum, or in the rotor using the cavity in the rotor as the film plenum.

Likewise, the invention is applicable to direct injection engines. Direct injection spark ignition engines have been under development since the 1920s and have received renewed focus in today's high efficiency environment. The technology involves injecting fuel after the air is compressed by the compression stroke, and then igniting it with a spark plug. FIG. 18 shows an embodiment that uses a pre-chamber to create a region of high fuel/air ratio around the spark plug to ensure ignition. Once the fuel and air in the pre-chamber is ignited, it acts as a torch with flame passing from the pre-chamber to the combustion chamber combusting the lower fuel air ratio mixture in the traditional combustion chamber. The added surface area due to the pre-chamber and the high velocity, hot gas jetting from the pre-chamber to the combustion chamber cause heat transfer losses higher than those found in traditional spark ignition engines. Proposed here is the novel concept of using film cooling to insulate the pre-chamber and especially the channel between the pre-chamber and the combustion chamber from the hot gases. This will reduce the heat transfer penalty of stratified charge engines using pre-chambers, making the technology more attractive.

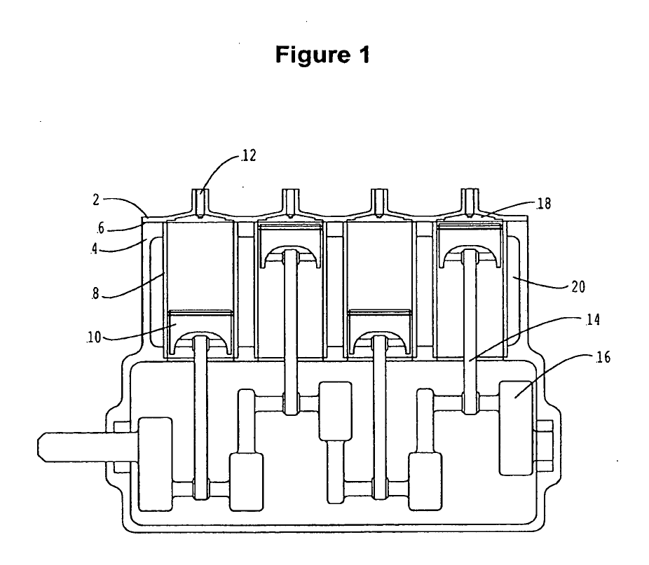

Turning now to the figures, which provide details on certain features of embodiments of the invention, FIG. 1 depicts a cutaway view from the side of an inline 4 cylinder spark ignition engine. The cylinder head 2 is bolted to the engine block 4. The mate face 6 between the two major structural pieces of the engine is sealed with the head gasket. The cylinder walls 8 are often separate pieces pressing to holes in the engine block 4. Pistons 10 reciprocate in the cylinders with the cycles of the engine. Spark plugs 12 are mounted in the cylinder head 2. The pistons are rotatably mounted to connecting rods 14 that transmit power to the crank shaft 16. The rotational position of the crank shaft that puts the piston at its highest point in the cylinder is called top dead center, and creates the smallest volume in the cylinder called the combustion chamber 18. The water jacket 20 is large cavities inside the engine block 4 allow cooling water to flow around and cool the cylinder walls 8.

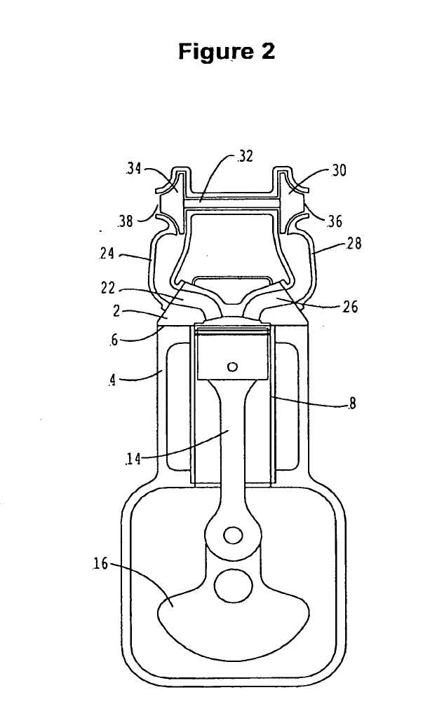

FIG. 2 is a cutaway view from the front of a turbocharged internal combustion engine. The cylinder head 2 is bolted to the engine block 4. The mate face 6 between the two major structural pieces of the engine is sealed with the head gasket. The cylinder walls 8 are often separate pieces pressing to holes in the engine block 4. The pistons are rotatably mounted to connecting rods 14 that transmit power to the crank shaft 16. Air enters the engine through the intake port 22 from the intake manifold 24. Air and combustion products exit the engine through the exhaust port 26 to the exhaust manifold 28. In a turbocharged engine, the exhaust gas passes through a turbine 30. The turbine extracts otherwise wasted energy from the exhaust gases to rotate the turbocharger shaft 32. The shaft is connected to a compressor 34 used to compress all the air entering the engine. The air exits the turbocharged engine through the outlet of the turbine 36. Air enters the turbocharged engine through the inlet of the compressor 38.

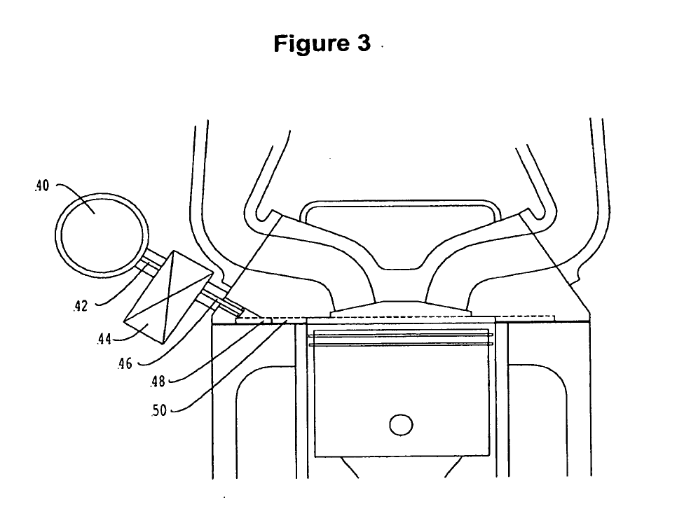

FIG. 3 is an enlargement of FIG. 2 in the region of the cylinder head. The figure shows a film plenum 40 acting as a supply of high pressure film. The film plenum is connected to pass film to a first film connection 42. The first film connection is connected to pass film to the film valve 44. The film valve controls the flow of film to the second film passage 46 into the film pad 48. The film pad is a wide recess in the cylinder head designed to pass film to other grooves in the cylinder head 50 acting as the film distribution system and film holes.

FIG. 4 shows the source of pressurized film to the film plenum 52 being the compressor of the turbocharger. The supply of air to the engine 54 is not connected to the compressor used to compress the air for the film system.

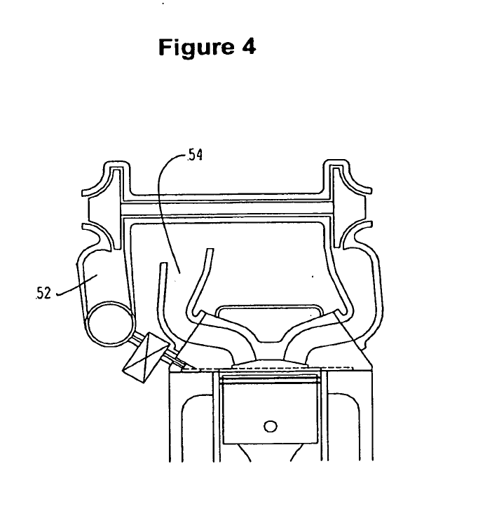

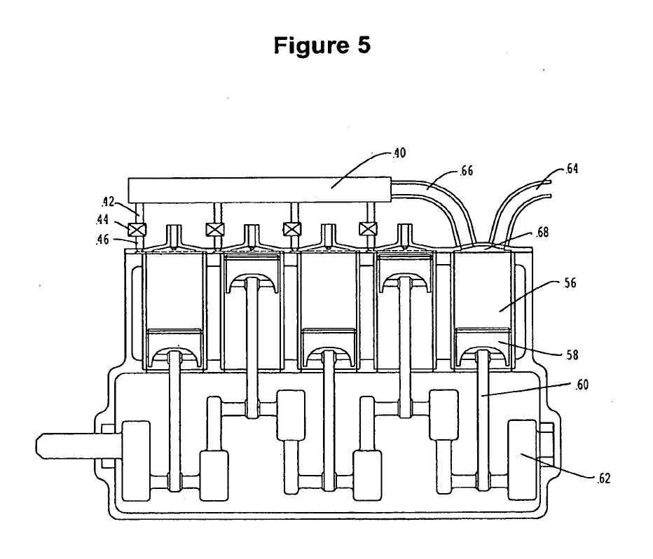

FIG. 5 shows a side view of a 4 cylinder spark ignition engine similar to FIG. 1. The engine has a film plenum 40 feeding air through many first film passages 42 to many film valves 44. The film valves control flow to second film passages 46 supplying air to film channels installed in the mate face between the cylinder head and engine block. The engine includes an additional cylinder 56 with a piston 58 connected with a connecting rod 60 to the engine crank shaft 62. The cylinder has an intake 64, and an exhaust 66. The added cylinder is used to compress film to supply the film plenum 40. The cylinder has a combustion chamber 68 different than the other power cylinders in that it does not have to be designed to manage combustion.

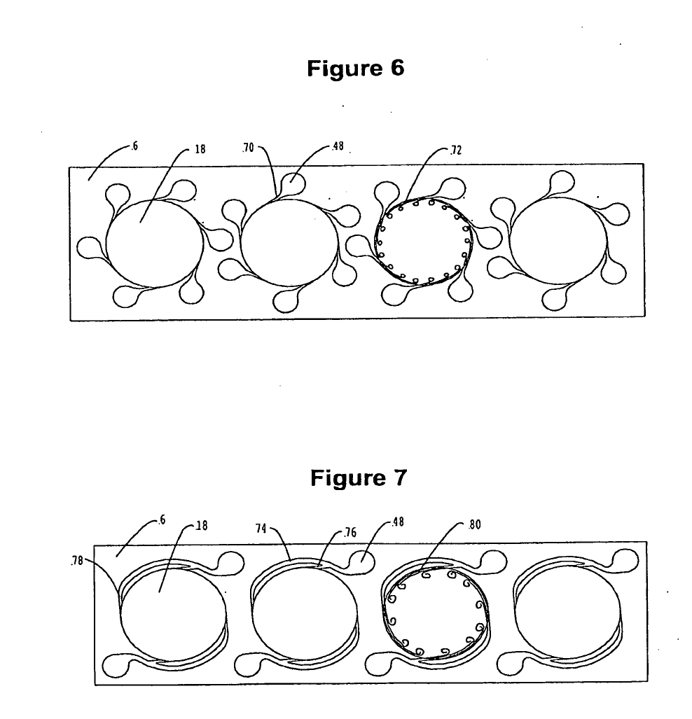

FIG. 6 is a view in the plane of the mate face 6. Four cylinders 18 are shown, each with six film pads 48 feeding six film holes 70. The film holes 70 are arranged substantially tangent to the curvature of the cylinder to create a film pattern 72 of tangentially flowing film around the cylinder.

FIG. 6 is a view in the plane of the mate face 6. Four cylinders 18 are shown, each with two film pads 48 each feeding a film channel 74 connected to two film holes 76 and 78. The film holes are arranged substantially tangent to the curvature of the cylinder to create a film pattern 80 of tangentially flowing film around the cylinder.

FIG. 8 is a view in the plane of the mate face 6. Four cylinders 18 are shown, each with one film pad 48 each feeding two film channels 74 connected to two film holes 76 and 78. The film holes are arranged substantially tangent to the curvature of the cylinder to create a film pattern 82 of tangentially flowing film around both sides of the cylinder.

FIG. 9 is a view in the plane of the mate face 6. Four cylinders 18 are shown, each with one film pad 48 each feeding two film channels 74. One film channel feeds holes 74 and 78 with the angle of the film holes relative to the flow direction in the film channel less than 90 degrees. In order to create a pattern of film 8 that is uniformly tangential in the cylinder, the other film channel feeds holes 84 and 86 whose angle relative to the flow direction in the film channel is greater than 90 degrees.

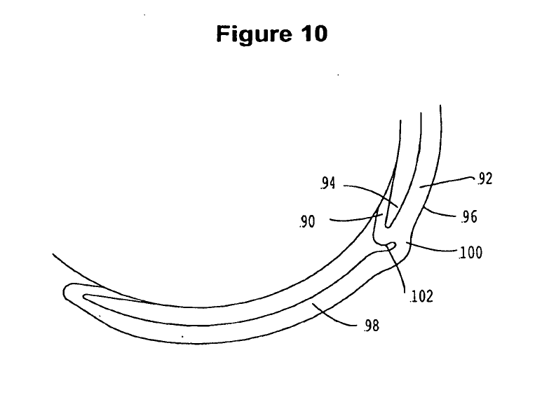

FIG. 10 is an enlargement of FIG. 9 in the region of two film holes 84 and 86. Film flows from the film pad down the first part of the film channel 92 to the first film hole 90. A scoop 102 is placed in the flow path after the film hole and before the second part of the film channel 98. The scoop directs flow from the channel into the first film hole. The outside edge of the film channel 96 is moved outward 100 to allow film to move around the scoop to the second part of the film channel.

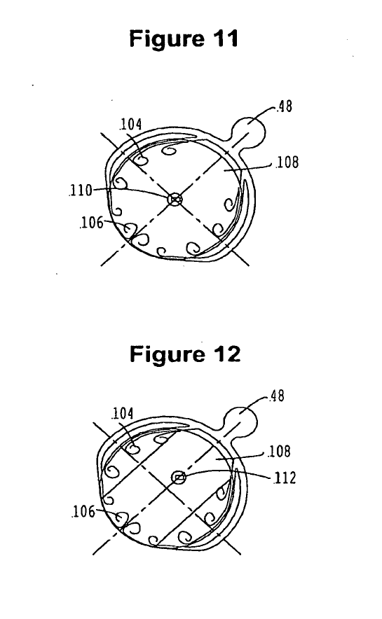

FIG. 11 is a reproduction of one cylinder from FIG. 8. Added to the figure is a spark plug 110 added to the center of the cylinder. The hole arrangement creates a region where no film is directed 108, a region where tangential flow of film covers the walls 104, and a region where two patterns of tangential flow collide and mix 106 to create a thick region of film coverage. In this film configuration, the region of no film coverage 108 is the part of the cylinder closest to the film pad 48.

FIG. 12 is a reproduction of FIG. 11. In order to reduce the risk of knock in the region of the cylinder not covered by film 108, the spark plug 112 is moved closer to the uncovered region than the region with the thick film layer 106.

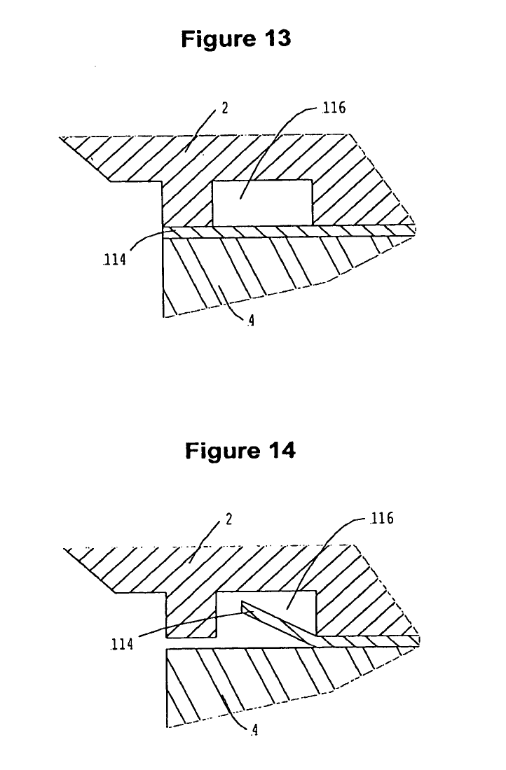

FIG. 13 is a cross section through the cylinder head 2 engine block 4 and head gasket 114. A film channel 116 is shown as a groove entirely in the cylinder head 2.

FIG. 14 is a cross section through the cylinder head 2 engine block 4 and head gasket 114. A film channel 116 is shown as a groove entirely in the cylinder head 2. The head gasket 114 has been deformed and forced to hang into the film channel 116.

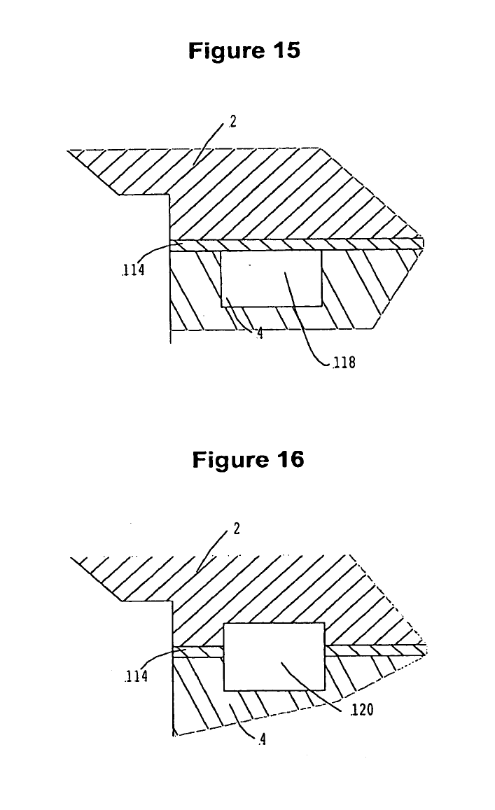

FIG. 15 is a cross section through the cylinder head 2 engine block 4 and head gasket 114. A film channel 118 is shown as a groove entirely in the engine block 4.

FIG. 16 is a cross section through the cylinder head 2 engine block 4 and head gasket 114. A film channel 120 is shown as a groove in both the cylinder head 2 and engine block 4 and a break in the head gasket 114.

FIG. 17 is a cross section through the cylinder head 2 engine block 4 and head gasket 114. A film channel 116 is shown as a groove entirely in the cylinder head 2. In order to support the head gasket, and prevent deformation like that shown in FIG. 14, a u-shaped structure 122 is placed in the film channel 116.

FIG. 18 is a cross section through the cylinder head 2 engine block 4 and head gasket 114. A film channel 116 is shown as a groove entirely in the cylinder head 2. In order to support the head gasket, and prevent deformation like that shown in FIG. 14, a plate structure 124 is placed across the film channel 116.

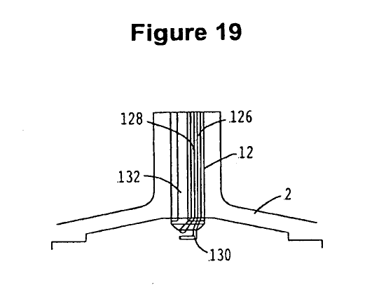

FIG. 19 is an enlargement of FIG. 1 in the region of the spark plug 12. In addition to the electrical leads 126 and 128, film passages 132 are added to direct film away from the spark leads and toward the walls of the cylinder head 2 around the spark plug 12.

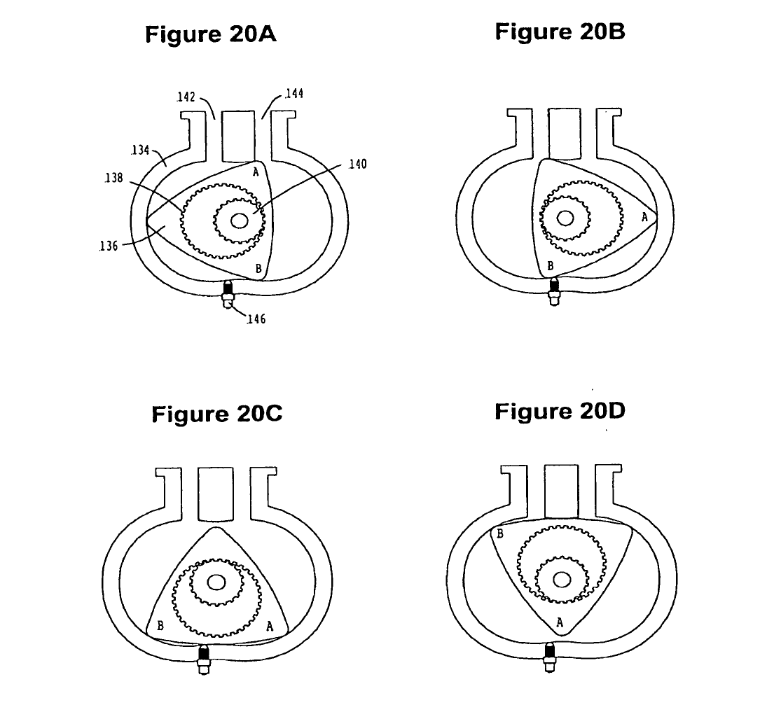

FIG. 20 explains the function of a Wankle or rotary engine in 5 steps. FIG. 20A is a cutaway view of the inner workings of the rotary engine. The stationary structural housing 134 has an inner wall designed such that a triangular rotor 136 can rotate within it with minimal clearances. The rotor 136 rotates eccentrically around a gear 140 causing the gear to rotate. The gear is on the drive shaft. The rotor has 3 sides, each acting as a piston face. The description here follows side AB. The housing 134 has an exhaust port 142, and intake port 144 and a position for a spark plug 146. In the position of FIG. 20A, face AB creates a cavity with the housing 134 accepting air into the cycle from the intake 144.

FIG. 20B shows the rotor 136 with side AB having closed of the intake 144 and compression the air trapped in its cavity. FIG. 20C shows the rotor 136 with side AB having compressed the air to its smallest volume and exposing the air to the spark plug 146. The spark plug 146 fires beginning the combustion process. FIG. 20D shows the rotor 136 with side AB trapping combusted air and expanding it, extracting work. FIG. 20E shows the rotor 136 with side AB exposing its cavity to the exhaust port 142, allowing the combustion products to exhaust.

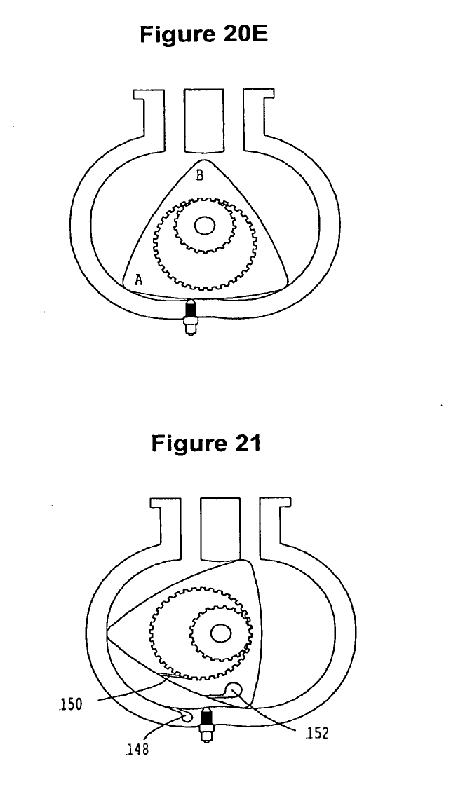

FIG. 21 shows the rotor 136 of the rotary engine with side AB in the expansion or power stroke, having just passed the spark plug 146. This is the hottest part of the cycle, and most appropriate for film cooling. Three film holes are added to the engine. A film hole 148 and feed system are added to the housing 134. A film hole 150 is added to the rotor using the cavity created by the eccentricity of the rotor 136 relative to the drive gear 140 as the film supply passage. A film hole 152 and feed system is added to the rotor 134.

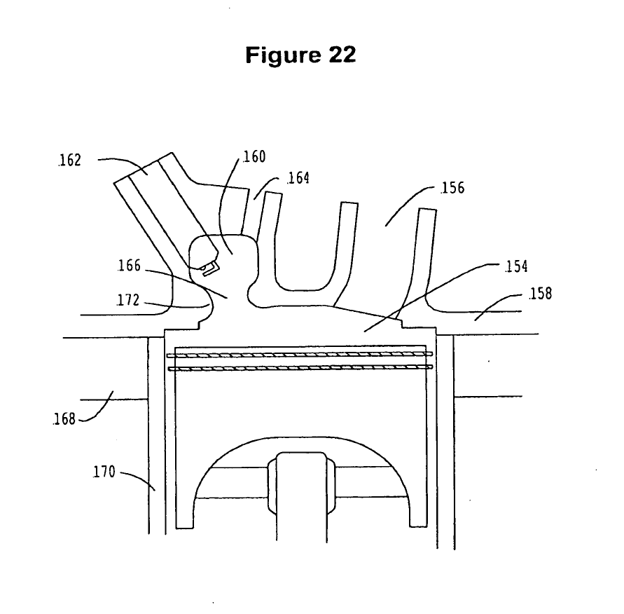

FIG. 22 is a cutaway view similar to FIG. 2 of a stratified charge spark ignition engine. This embodiment includes a combustion chamber 154 fed air through an intake port 156. The cylinder head 158 also includes a pre-chamber 160 designed to hold a high fuel air mixture around the spark plug 162. The high fuel air mixture enters the pre-chamber through an auxiliary intake port 164. When the high fuel air mixture is ignited by the spark plug 162, it passes rapidly from the pre-chamber 160 through the pre-chamber passage 166 to the combustion chamber. The high speed, hot gases transfer large amounts of heat to the walls of the pre-chamber passage 172.

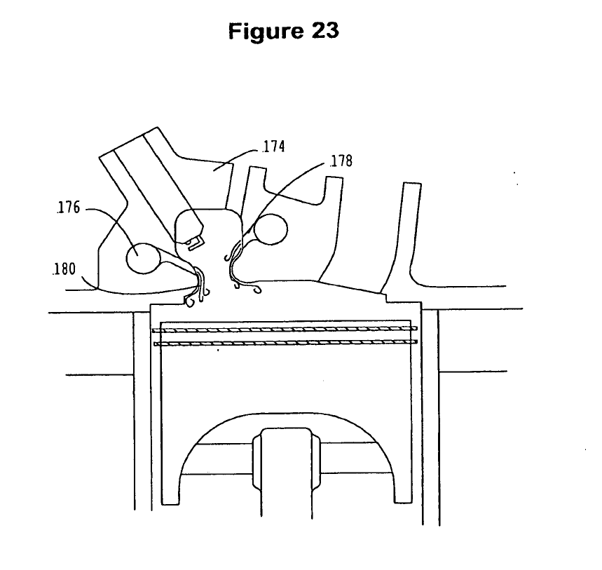

FIG. 23 is similar to FIG. 22 and is a cutaway view of a stratified charge spark ignition engine. The cylinder head 174 is altered to include an annular film supply chamber 176 around the pre-chamber 160 feeding film holes 178 aimed to create a film pattern 180 to reduce heat transfer to the pre-chamber passage 166.

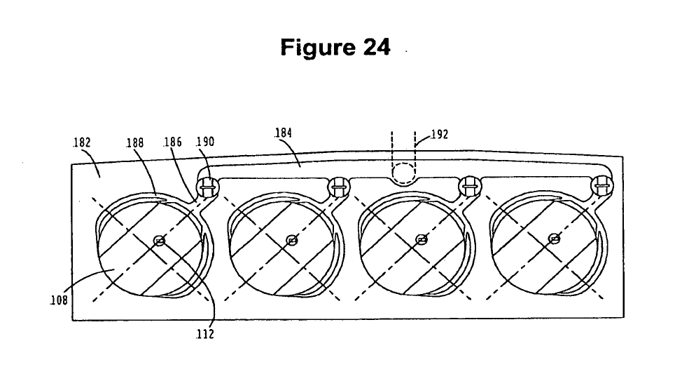

FIG. 24 depicts a cross-section of an IC engine showing a plurality of cylinders 108 with spark plugs 112 in an engine block 182 comprising a film plenum 184. The film plenum 184 is fed from a film supply 192. The cylinders 108 each have a film supply channel 186 feeding a film cooling circuit 188. A film control valve 190 mounted between the film plenum 184 and the film supply channel 186 controls the flow of film without taking the film out of the engine block/cylinder head assembly.

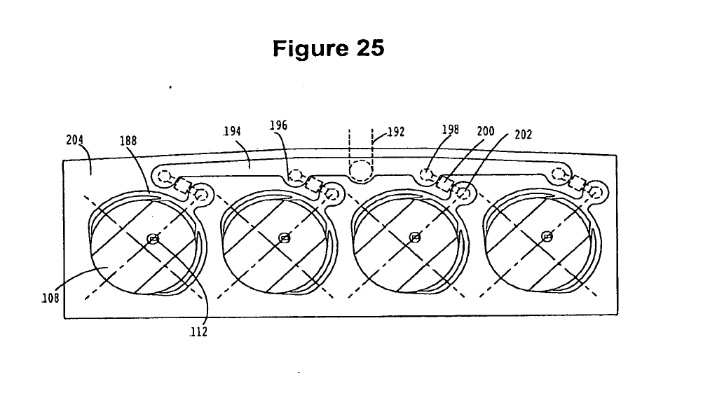

FIG. 25 depicts a cross-section of an IC engine showing a plurality of cylinders 108 with spark plugs 112. The engine block 204 includes a film plenum 194. The film plenum 194 is fed from a film supply 192. The film plenum 194 has film pads 196 used to connect to the supply 198 of a conventional film control valve 200 outside of the engine block/cylinder head assembly. The film control valve 200 controls flow of film to the film pad 202 on each film cooling circuit 188.

It will be apparent to those skilled in the art that various modifications and variations can be made in the practice of the present invention and in construction of the articles of manufacture and products of the invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. An internal combustion engine comprising a block and a head,
wherein the block comprises a surface defining a face for physical connection of the block to the head, and the head comprises a surface defining a face for physical connection of the head to the block, and wherein the head and block are connected, either directly or through an intermediary element at a region defining a mate face; and
wherein the block and head each comprise at least one surface that, taken together, form a wall of at least one chamber,
said wall of said chamber comprising at least one film hole for introduction of a fluid into the chamber at an angle substantially parallel to the plane of the mate face.

2. The engine of claim 1, wherein at least one film hole is located in the chamber wall at a position that results in displacement of end gas upon introduction of a film into the chamber.

3. The engine of claim 1, wherein the film channel is a groove in one or more surface comprising the mate face.

4. The engine of claim 1, wherein the film channel is a groove in either the head or engine block, where a support structure is provided to support the gasket or seal at the site of the channel.

5. The engine of claim 1, further comprising a film manifold located in a groove in the mate face.

6. The engine of claim 1, further comprising a compressor that compresses the fluid, wherein the compressor is driven by a turbine run off of exhaust gas from the engine, a piston-cylinder combination, an electric pump, or a belt-driven pump.

7. The engine of claim 1, which is a rotary engine, an HCCI engine, or a direct injection engine.

8. The engine of claim 1, wherein the fluid includes fuel in a fuel to fluid weight ratio less than or substantially equal to that which exists in the chamber when fluid injection begins.

9. The engine of claim 1, wherein the engine comprises 1, 2, 3, 4, 6, 8, or 12 chambers.

10. A vehicle comprising the engine of claim 1.

11. A stationary power generation unit comprising the engine of claim 1.

12. An internal combustion engine comprising at least one film hole for introduction of a fluid into the chamber wherein the fluid includes fuel in a fuel to fluid weight ratio less than or substantially equal to that which exists in the chamber when fluid injection begins.

13. A cylinder head for a internal combustion engine, said head comprising at least one passageway for passage of a fluid to at least one film hole in the surface of at least one cylinder wall defined, at least in part, by the cylinder head.

14. The cylinder head of claim 13, further comprising in said passageway one or more manifolds for supply of a film to at least one cylinder defined by a cylinder wall.

15. The cylinder head of claim 13, wherein said passageway is present, at least in part, at or in a surface of the cylinder head defining a face for physical connection, either directly or ultimately, of the head to an engine block.

16. A vehicle comprising the cylinder head of claim 13.

17. A stationary power generation unit comprising the cylinder head of claim 13.

18. An engine block for an internal combustion engine, said block comprising at least one passageway for passage of a fluid to at least one film hole in a surface of at least one cylinder wall defined, at least in part, by the engine block.

19. The engine block of claim 18, further comprising in said passageway one or more manifolds for supply of a film to at least one cylinder defined by a cylinder wall.

20. The engine block of claim 18, wherein said passageway is present, at least in part, at or in a surface of the engine block defining a face for physical connection, either directly or ultimately, of the block to a cylinder head.

21. A vehicle comprising the engine block of claim 18.

22. A stationary power generation unit comprising the engine block of claim 18.

23. The engine of claim 1, wherein at least one film hole is present at the mate face.

24. The engine of claim 1, wherein the engine comprise an intermediary element at the mate face, which comprises a seal interposed between and in physical contact with the block and head.

25. The engine of claim 1, wherein the surface forming a wall of a chamber comprises more than one film hole.

26. The engine of claim 1, wherein the engine comprises more than one chamber.

27. The engine of claim 1, comprising a film channel in or in proximity to either or both of the head and block surfaces at the mate face region.

28. The engine of claim 1, further comprising a source of the fluid and at least one passageway connecting the film hole to the source of the fluid.

29. The engine of claim 1, further comprising at least one control valve to control the timing and/or volume of fluid entering the chamber.

30. The engine of claim 1, wherein the film hole is designed such that fluid introduced into the chamber is introduced against the surface of the chamber.

31. The engine of claim 1, wherein the film hole is present in the spark plug.

32. An internal combustion engine comprising a block and a head, wherein the block and head are physically connected at a mate face, wherein the block and head each comprise at least one surface that, taken together, form a wall of a chamber, said wall of said chamber comprising at least one film hole for introduction of a fluid into the chamber that causes end gas to burn substantially as a result of the combustion wave and not auto-ignition or knock, more completely and/or effectively than an identical engine without the film hole(s).

33. The engine of claim 32, wherein at least one film hole is present at the mate face.

34. The engine of claim 32, wherein the film hole is designed to allow introduction of the fluid against the surface of the chamber.

35. The engine of claim 32, wherein the film hole is designed to allow introduction of the fluid substantially parallel to the mate face.

36. The engine of claim 32, wherein the film hole is designed to cause displacement of end gas by the fluid film introduced through the film hole.

37. The engine of claim 32, wherein the film hole location is selected in conjunction with the chamber shape to cause displacement of end gas upon introduction of the fluid through the film hole during operation of the engine.

38. The engine of claim 32, wherein the film fluid includes fuel in a lower fuel to air ratio than in the cylinder.

39. A vehicle comprising the engine of claim 32.

40. A stationary power generation unit comprising the engine of claim 32.

41. A method of fabricating an internal combustion engine or a portion thereof, said method comprising providing at least one film hole in a surface defining a piston cylinder or combustion chamber, wherein the film hole is present at a mate face between a cylinder head and engine block of the engine.

42. The method of claim 41, wherein the film hole is designed such that fluid introduced into the chamber from the film hole is directed against the surface of the chamber.

43. The method of claim 41, wherein the film hole is designed such that fluid introduced into the chamber from the film hole is introduced substantially parallel to the mate face.

44. The method of claim 41, further comprising providing at least one passageway for a fluid to travel from outside the engine to the film hole.

45. The method of claim 41, wherein the method comprises providing more than one film hole.

46. A method of introducing a film into an internal combustion engine, said method comprising:
providing an internal combustion engine having at least one chamber defined by a surface of a cylinder head and a surface of an engine block, wherein the cylinder head and engine block are physically connected at a mate face, wherein the surface of the chamber comprises at least one film hole for introduction of a fluid into the chamber to displace end gas; and
operating the engine;
wherein operating the engine comprises introducing a fluid into the chamber through the film hole.

47. The method of claim 46, wherein the method is a method of improving the fuel efficiency of an engine by causing the displaced end gas to burn, wherein the improvement is seen as compared to an identical engine but without the film hole(s).

48. The method of claim 46, wherein the method is a method of film cooling of an engine.

49. The method of claim 46, wherein the method improves the percentage of fuel burned by the engine, as compared to an identical engine without the film hole(s).

50. The method of claim 46, wherein at least one film hole is located at the mate face.

51. The method of claim 46, wherein the temperature of the fluid, when introduced into the chamber, is substantially the same as the surface at the film hole.

52. The method of claim 46, where in the temperature of the fluid is reduced by a heat exchanger with fuel as the fluid receiving the heat.
